(19) United States
(12) Patent Application Publication
(10) Pub. No.: US 2018/0075868 A1
(43) Pub. Date: Mar. 15, 2018

(54) MAGNETIC RECORDING HEAD AND DISK DEVICE HAVING THE SAME

(71) Applicant: KABUSHIKI KAISHA TOSHIBA, Tokyo (JP)

(72) Inventors: Katsuhiko KOUI, Yokohama Kanagawa (JP); Kenichiro YAMADA, Minato Tokyo (JP); Tomoko TAGUCHI, Kunitachi Tokyo (JP)

(21) Appl. No.: 15/445,822

(22) Filed: Feb. 28, 2017

(30) Foreign Application Priority Data
Sep. 12, 2016 (JP) 2016-177670

(51) Int. Cl. G11B 5/39; G11B 5/127

(52) U.S. Cl. CPC G11B 5/3912; G11B 5/1278

(57) ABSTRACT

A magnetic recording head includes a main magnetic pole extending to an air bearing surface of the magnetic recording head and having an end portion that is exposed at the air bearing surface, a magnetic shield having an end portion that is exposed at the air bearing surface and faces the end portion of the main magnetic pole with a gap therebetween, a stacked-layer element disposed in the gap, and including a first conductive layer in contact the main magnetic pole, a second conductive layer in contact with the magnetic shield, and an magnetic permeability adjusting layer disposed between the first conductive layer and the second conductive layer, and first and second terminals between which a current flows through the main magnetic pole, the stacked-layer element, and the magnetic shield when the current is supplied to one of the terminals.

### CROSS-REFERENCE TO RELATED APPLICATION

This application is based upon and claims the benefit of priority from Japanese Patent Application No. 2016-177670, filed Sep. 12, 2016, the entire contents of which are incorporated herein by reference.

### FIELD

Embodiments described herein relate generally to a magnetic recording head and a disk device having the magnetic recording head.

### BACKGROUND

A disk device of one type includes a magnetic recording head for perpendicular magnetic recording, which is beneficial in increasing recording density and capacity of a magnetic disk. Such a magnetic recording head includes a main magnetic pole that generates a perpendicular magnetic field, a shield magnetic pole placed to face the main magnetic pole with a gap therebetween, and a coil for passing a magnetic flux through the main magnetic pole. In such a magnetic recording head, as the gap between the main magnetic pole and the shield magnetic pole decreases, recording density increases.

However, intensity of magnetic field generated by the coil may decrease as the gap decreases, because some of the magnetic flux from the main magnetic pole may extend to the shield magnetic pole. In order to solve this problem, a structure that has a smaller area in which the main magnetic pole and the shield magnetic pole face each other is proposed. However, in this case, magnetization of the shield magnetic pole may be saturated by the magnetic field from the main magnetic pole, which results in a significant decrease in the function of the shield magnetic pole as a magnetic shield.

### DESCRIPTION OF THE DRAWINGS

FIG. 1 is a perspective view of a hard disk drive (hereinafter, an HDD) according to an embodiment.

FIG. 2 is a side view of a magnetic head and a suspension in the HDD.

FIG. 3 is an enlarged cross-sectional view of a portion of the magnetic head.

FIG. 4 is a schematic perspective view of a recording head of the magnetic head.

FIG. 5 is an enlarged cross-sectional view of an ABS-side end portion of the recording head, taken along a track center.

FIG. 6 schematically depicts a magnetic field generated around the recording head.

FIG. 7 depicts a relationship between height of a magnetic permeability adjusting element of the recording head and intensity of the recording magnetic field.

FIG. 8 is a cross-sectional view of an enlarged ABS-side end portion of a recording head of an HDD according to a first modified example, taken along a track center.

### DETAILED DESCRIPTION

An embodiment provides a magnetic recording head and a disk device having higher recording density.

In general, according to an embodiment, a magnetic recording head includes a main magnetic pole extending to an air bearing surface of the magnetic recording head and having an end portion that is exposed at the air bearing surface, a magnetic shield having an end portion that is exposed at the air bearing surface and faces the end portion of the main magnetic pole with a gap therebetween, a stacked-layer element disposed in the gap, and including a first conductive layer in contact with the end portion of the main magnetic pole, a second conductive layer in contact with the end portion of the magnetic shield, and an magnetic permeability adjusting layer formed of a magnetic material containing at least one of iron, cobalt, and nickel and disposed between the first conductive layer and the second conductive layer, and first and second terminals between which a current flows through the main magnetic pole, the stacked-layer element, and the magnetic shield when the current is supplied to one of the terminals

Hereinafter, a disk device according to an embodiment will be described with reference to the drawings.

The following disclosure is an example, and anything that is an appropriate modification and is easily conceivable by a person skilled in the art within the sprit of the embodiment is included in the scope of the embodiment. Moreover, in order to make the description clearer, the width, thickness, shape, and so forth of each portion in the drawings may be presented in a more schematic form than actual, but these are for illustrative purposes only and do not limit the interpretation of the embodiment. Furthermore, in the present disclosure, an element similar to the element described in relation to the already-used drawing will be identified with the same character and the detailed explanation thereof may be omitted as appropriate.

### First Embodiment

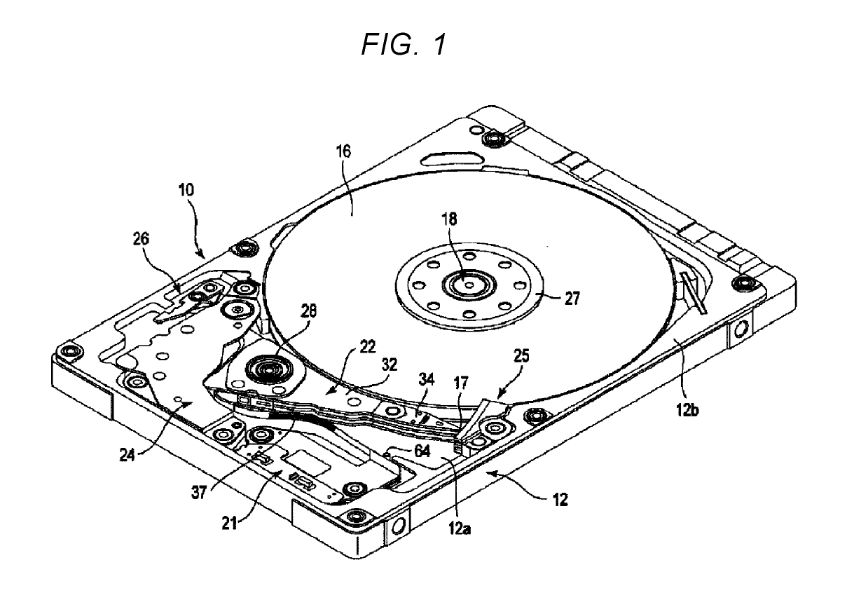

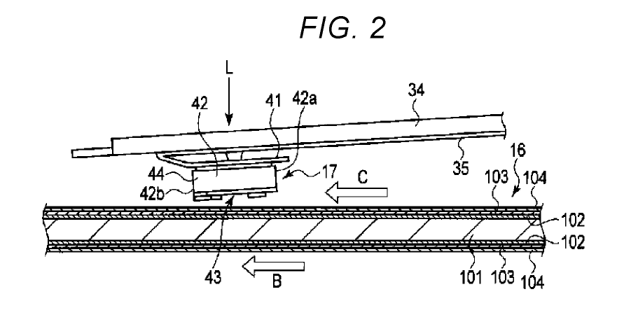

FIG. 1 depicts an internal structure of a hard disk drive (HDD) according to an embodiment as a disk device with a top cover thereof removed, and FIG. 2 depicts a magnetic head in a floating state. As depicted in FIG. 1, the HDD includes a housing 10. The housing 10 has a base 12 having the shape of a rectangular box with an opening in the top face thereof and an unillustrated top cover that is secured to the base 12 with a plurality of screws and closes the upper-end opening of the base 12. The base 12 has a rectangular bottom wall 12a and a side wall 12b vertically formed along an outer edge of the bottom wall 12a.

In the housing 10, as a recording medium, two magnetic disks 16, for example, and a spindle motor 18 as a driving portion that supports and rotates the magnetic disks 16 are provided. The spindle motor 18 is disposed on the bottom wall 12a. Each magnetic disk 16 includes a magnetic recording layer on upper and lower surfaces thereof. The magnetic disks 16 are coaxially fit onto an unillustrated hub of the spindle motor 18 and are clamped by a clamping spring 27, thereby being fixed to the hub. As a result, the magnetic disks 16 are supported in a state in which the magnetic disks 16 are located parallel to the bottom wall 12a of the base 12. The magnetic disks 16 are rotated by the spindle motor 18 at a predetermined speed.

In the housing 10, a plurality of magnetic heads 17 that performs recording and reproduction of information on the magnetic disks 16 and a carriage assembly 22 that movably supports the magnetic heads 17 with respect to the magnetic disks 16 are provided. Moreover, in the housing 10, a flexible printed circuit board (FPC) unit 21 on which electronic components such as a voice coil motor (hereinafter referred to as a VCM) 24 that turns and positions the carriage assembly 22, a ramp load mechanism 25 that holds the magnetic heads 17 in unloading positions separated from the magnetic disks 16 when the magnetic heads 17 move to outermost edges of the magnetic disks 16, a latch mechanism 26 that holds the carriage assembly 22 in an evacuation position when an impact or the like acts on the HDD, and a conversion connector are mounted is provided.

To the outer surface of the base 12, an unillustrated control circuit substrate is secured with screws and is located so as to face the bottom wall 12a. The control circuit substrate controls the operation of the spindle motor 18 and controls the operation of the VCM 24 and the magnetic heads 17 via the FPC unit 21.

The carriage assembly 22 includes a bearing portion 28 that is fixed on the bottom wall 12a of the base 12, a plurality of arms 32 extending from the bearing portion 28, and elastically deformable suspensions 34, each having the shape of an elongated plate. Each suspension 34 includes a base end fixed to the tip of the corresponding arm 32 by spot welding or bonding and extending from the arm 32. On an extension end of each suspension 34, the corresponding magnetic head 17 is supported. The suspensions 34 and the magnetic heads 17 face each other with interposing the magnetic disks 16 therebetween.

As depicted in FIG. 2, each magnetic head 17 is configured as a floating-type head and has a slider 42 having the shape of a virtually rectangular parallelepiped and a head portion 44 for recording and reproduction, the head portion 44 provided at an outflow end (a trailing end) of the slider 42. The magnetic head 17 is fixed to a gimbals spring 41 provided at a tip portion of each suspension 34. A head load L in the direction of the front surface of the magnetic disk 16 is applied to each magnetic head 17 by the elasticity of the suspension 34. As depicted in FIGS. 1 and 2, each magnetic head 17 is electrically connected to the FPC unit 21 via a wiring member 35 fixed on the suspension 34 and the arm 32 and a relay FPC 37.

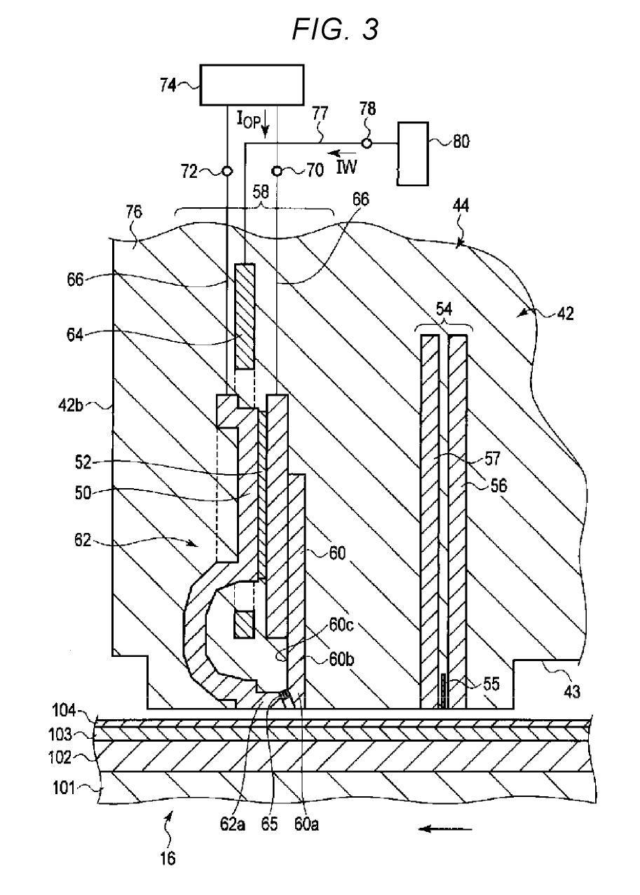

Next, configurations of the magnetic disk 16 and the magnetic head 17 will be described in detail. FIG. 3 is a cross-sectional view of the enlarged head portion 44 of the magnetic head 17 and the enlarged magnetic disk 16.

As depicted in FIGS. 1 to 3, the magnetic disk 16 includes a substrate 101 that is formed of a non-magnetic substance in the shape of a circular plate having a diameter of about 2.5 inches (6.35 cm), for example. On each front surface of the substrate 101, a soft magnetic layer 102 formed of a material of soft magnetic characteristics is stacked as an under layer, a magnetic recording layer 103 having magnetic anisotropy in a direction perpendicular to a disk surface is stacked on the soft magnetic layer 102, and a protective film layer 104 is stacked on the magnetic recording layer 103.

As depicted in FIGS. 2 and 3, the slider 42 of the magnetic head 17 is formed of a sintered body (AlTiC) of alumina and titanium carbide, for example, and the head portion 44 is formed by stacking thin films. The slider 42 has a rectangular disk-facing surface (an air bearing surface (ABS)) 43 facing the front surface of the magnetic disk 16. The slider 42 floats by an airflow C that is generated between the disk front surface and the ABS 43 by the rotation of the magnetic disk 16. The direction of the airflow C is the same as a rotation direction B of the magnetic disk 16. The slider 42 is placed in such a way that, with respect to the front surface of the magnetic disk 16, the longitudinal direction of the ABS 43 is roughly the same as the direction of the airflow C.

The slider 42 has a leading end 42a located on the inflow side of the airflow C and a trailing end 42b located on the outflow side of the airflow C. In the ABS 43 of the slider 42, unillustrated leading step, trailing step, side step, negative-pressure cavity, and so forth are formed.

As depicted in FIG. 3, the head portion 44 includes a reproducing head 54 and a recording head (a magnetic recording head) 58 formed at the trailing end 42b of the slider 42 by a thin-film process, and is formed as a separation-type magnetic head. The reproducing head 54 and the recording head 58 are covered with a protective insulating film 76 except for a portion exposed at the ABS 43 of the slider 42. The protective insulating film 76 forms the outside shape of the head portion 44.

The reproducing head 54 includes a magnetic film 55 having the magnetoresistive effect and shield films 56 and 57 placed at the trailing-side and the leading-side of the magnetic film 55 so as to sandwich the magnetic film 55. The lower ends of these magnetic film 55 and shield films 56 and 57 are exposed at the ABS 43 of the slider 42. The recording head 58 is provided on the side of the slider 42 where the trailing end 42b is located with respect to the reproducing head 54.

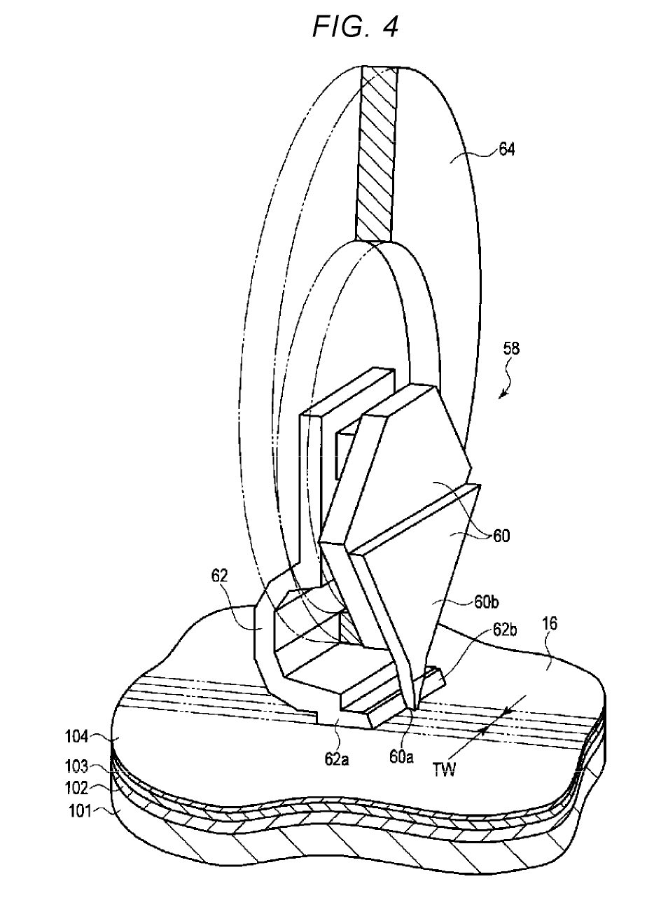

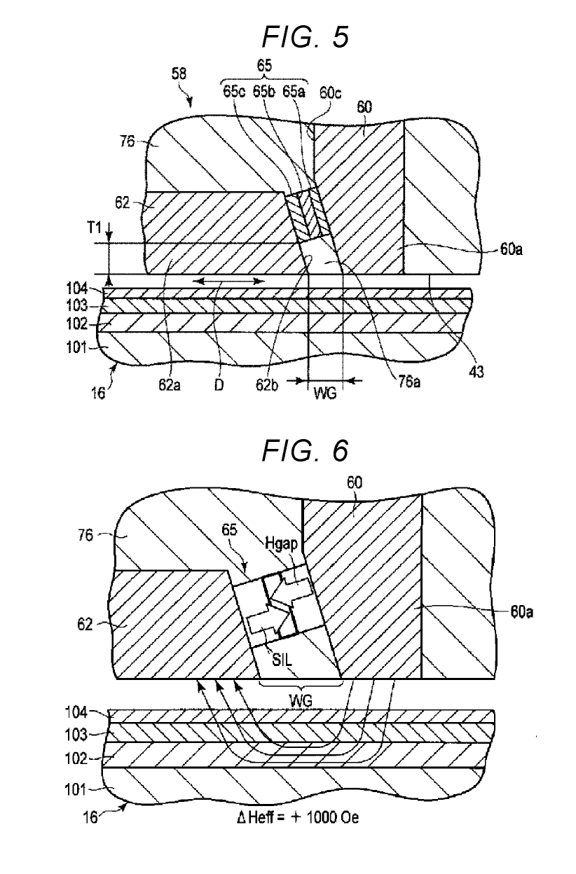

FIG. 4 is a schematic perspective view of the recording head 58 and the magnetic disk 16, and FIG. 5 is a cross-sectional view of an enlarged end portion of the recording head 58 on the side thereof where the magnetic disk 16 is located taken along a track center.

As depicted in FIGS. 3 to 5, the recording head 58 has a main magnetic pole 60 that is formed of a high saturated magnetization material and generates a perpendicular recording magnetic field with respect to the front surface of the magnetic disk 16, a trailing shield (a write shield magnetic pole) 62 formed of a soft magnetic material, the trailing shield 62 placed on the trailing-side of the main magnetic pole 60 and provided to close a magnetic path efficiently via the soft magnetic layer 102 directly under the main magnetic pole 60, a recording coil 64 placed so as to wind around a magnetic core (a magnetic circuit) including the main magnetic pole 60 and the trailing shield 62 in order to pass a magnetic flux through the main magnetic pole 60 when a signal to write data on the magnetic disk 16 is input, and a magnetic permeability adjusting element 65 placed between a tip portion 60a of the main magnetic pole 60 on the side thereof where the ABS 43 is located and the trailing shield 62 in such a way as to be separated from the ABS 43.

The main magnetic pole 60 formed of a soft magnetic material extends almost perpendicularly with respect to the front surface of the magnetic disk 16 and the ABS 43. A lower end portion of the main magnetic pole 60 on the side thereof where the ABS 43 is located has a narrowed portion 60b which is narrowed in the shape of a funnel in a track width direction so as to taper down toward the ABS 43 and a tip portion 60a of a predetermined width, the tip portion 60a extending from the narrowed portion 60b to the side where the magnetic disk 16 is located. The tip of the tip portion 60a, that is, the lower end thereof is exposed at the ABS 43 of the magnetic head 17. The width of the tip portion 60a in the track width direction nearly corresponds to the width TW of the track in the magnetic disk 16. Moreover, the main magnetic pole 60 has a shield-side end face 60c that extends almost perpendicularly with respect to the ABS 43 and faces the trailing-side. In an example, an end of the shield-side end face 60c on the side thereof where the ABS 43 is located extends while tilting toward the shield-side (the trailing-side) with respect to the ABS 43.

The trailing shield 62 formed of a soft magnetic material is formed almost in the shape of the letter L. The trailing shield 62 has a tip portion 62a that faces the tip portion 60a of the main magnetic pole 60 with a write gap WG therebetween and a connection portion (a backgap portion) 50 that is separated from the ABS 43 and connected to the main magnetic pole 60. The connection portion 50 is connected to an upper portion of the main magnetic pole 60, that is, the upper portion which is away from the ABS 43 toward the back side or upward, with a non-conductive material 52 placed therebetween.

The tip portion 62a of the trailing shield 62 is formed in the shape of an elongated rectangle. A lower-end surface of the trailing shield 62 is exposed at the ABS 43 of the slider 42. A leading-side end face (a main magnetic pole-side end face) 62b of the tip portion 62a extends in a width direction of the track of the magnetic disk 16 and tilts toward the trailing-side with respect to the ABS 43. In a lower end portion (portion of the tip portion 60a and the narrowed portion 60b) of the main magnetic pole 60, the leading-side end surface 62b faces the shield-side end surface 60c of the main magnetic pole 60 substantially parallel thereto with the write gap WG therebetween.

As depicted in FIG. 5, in the write gap WG, the magnetic permeability adjusting element 65 is provided between the tip portion 60a of the main magnetic pole 60 and the trailing shield 62 and is separated from the ABS 43 by a height T1, that is, provided in a position higher than the ABS 43. The magnetic permeability adjusting element 65 has a function of preventing only flow of the magnetic flux into the trailing shield 62 from the main magnetic pole 60, that is, oscillating spin torque such that the magnetic permeability of the write gap WG becomes effectively negative.

Specifically, the magnetic permeability adjusting element 65 includes an intermediate layer (a first non-magnetic conductive layer) 65a having electrical conductivity, an adjusting layer 65b, and a conduction cap layer (a second non-magnetic conductive layer) 65c having electrical conductivity, and is formed of these layers stacked in order from the side where the main magnetic pole 60 is located to the side where the trailing shield 62 is located, that is, stacked in order in a traveling direction D of the magnetic head 17. Each of the intermediate layer 65a, the adjusting layer 65b, and the conduction cap layer 65c has a film surface that is parallel to the shield-side end face 60c of the main magnetic pole 60, that is, the film surface extending in a direction intersecting the ABS 43.

Here, the direction in which the intermediate layer 65a, the adjusting layer 65b, and the conduction cap layer 65c are stacked is not limited to the direction described above; the intermediate layer 65a, the adjusting layer 65b, and the conduction cap layer 65c may be stacked in an opposite direction, that is, may be stacked from the side where the trailing shield 62 is located to the side where the main magnetic pole 60 is located.

For example, the intermediate layer 65a can be formed as a metal layer of Cu, Au, Ag, Al, Ir, or an NiAl alloy and formed of a material that does not interfere with spin conduction. The intermediate layer 65a is formed directly on the shield-side end surface 60c of the main magnetic pole 60. The adjusting layer 65b is formed of, for example, a magnetic metal which is selected from Fe, Co, and Ni and a soft magnetic metal alloy containing at least one of Fe, Co, and Ni. For the conduction cap layer 65c, a material that is a non-magnetic metal and interrupts spin conduction can be used. The conduction cap layer 65c can be formed of, for example, at least one selected from Ta, Ru, Pt, W, and Mo or an alloy containing at least one selected from Ta, Ru, Pt, W, and Mo. The conduction cap layer 65c is formed directly on the leading-side end face 62b of the trailing shield 62.

The intermediate layer 65a is formed so as to have a film thickness of 1 to 5 nm, for example, which transfers the spin torque from the main magnetic pole 60, the film thickness with which exchange interaction is sufficiently weakened. The conduction cap layer 65c simply has to have a film thickness of 1 nm or more, for example, which interrupts the spin torque from the trailing shield 62, the film thickness with which exchange interaction is sufficiently weakened.

Since the direction of the magnetization of the adjusting layer 65b has to be opposite to the magnetic field due to the spin torque from the main magnetic pole 60, a lower saturation magnetic flux density of the adjusting layer 65b is preferable. On the other hand, in order to shield the magnetic flux effectively by the adjusting layer 65b, a higher saturation magnetic flux density of the adjusting layer 65b is preferable. Since the magnetic field in the write gap WG is about 10 to 15 kOe, even when the saturation magnetic flux density of the adjusting layer 65b is set at about 1.5 T or higher, the improvement effect is less likely to be achieved. Based on those described above, the saturation magnetic flux density of the adjusting layer 65b is preferably 1.5 T or less. More specifically, forming the adjusting layer 65b in such a way that the product of the film thickness and the saturation magnetic flux density of the adjusting layer 65b becomes 20 nmT or less is desirable.

Moreover, the adjusting layer 65b of the magnetic permeability adjusting element 65 can be formed in an arbitrary position between the main magnetic pole 60 and the trailing shield 62 (the write gap WG). However, since the adjusting layer 65b formed near the ABS 43 of the slider 42 affects the recording magnetic field, the magnetic permeability adjusting element 65 is preferably formed in a position which is in the write gap WG and is away from the ABS 43 in an upward direction. More specifically, the adjusting layer 65b is preferably provided in a position in which the distance (the height T1) between the edge of the adjusting layer 65b of the magnetic permeability adjusting element 65 on the side where the ABS 43 is located and the ABS 43 becomes longer than the width WG of the write gap in the traveling direction D of the magnetic head 17 (T1>WG).

In order to concentrate the flow of the current in a direction perpendicular to the film surfaces of the intermediate layer 65a, the adjusting layer 65b, and the conduction cap layer 65c, the perimeter of the magnetic permeability adjusting element 65 is covered with an insulating layer, for example, the protective insulating film 76 except for a portion in contact with the main magnetic pole 60 and the trailing shield 62. As a result, a protective insulating film 76a is formed also between the magnetic permeability adjusting element 65 and the ABS 43, and a lower face of this protective insulating film 76a forms portion of the ABS 43.

The main magnetic pole 60 can be formed of a soft magnetic metal alloy of which main ingredient is an Fe—Co alloy. The main magnetic pole 60 also has the function as an electrode for applying a current to the intermediate layer 65a. The trailing shield 62 can be formed of a soft magnetic metal alloy of which main ingredient is an Fe—Co alloy. The trailing shield 62 also serves as an electrode for applying a current to the conduction cap layer 65c.

As depicted in FIG. 3, the main magnetic pole 60 and the trailing shield 62 are connected to a power source 74 via wiring 66, feeding terminals 70 and 72, and wiring, whereby a current circuit that applies a (DC) current Iop in series from the power source 74 through the wiring 66, the main magnetic pole 60, the magnetic permeability adjusting element 65, and the trailing shield 62 is formed.

The recording coil 64 is wound around the connection portion 50 between the main magnetic pole 60 and the trailing shield 62, for example. The recording coil 64 is connected to a terminal 78 via wiring 77, and a second power source 80 is connected to this terminal 78. A recording current Iw which is supplied from the second power source 80 to the recording coil 64 is controlled by a control unit of the HDD. When a signal is written on the magnetic disk 16, a predetermined recording current Iw is supplied from the second power source 80 to the recording coil 64, whereby a magnetic flux is passed through the main magnetic pole 60 to make the main magnetic pole 60 generate a recording magnetic field.

In accordance with the HDD configured as described above, as a result of the VCM 24 being driven, the carriage assembly 22 turns, whereby each magnetic head 17 is moved to an area above a desired track of the magnetic disk 16 and is positioned in place. Moreover, as depicted in FIG. 2, the magnetic head 17 floats by the airflow C that is generated between the disk front surface and the ABS 43 by the rotation of the magnetic disk 16. When the HDD is operating, the ABS 43 of the slider 42 faces the disk front surface with a space therebetween. In this state, reading of recorded information from the magnetic disk 16 is performed by the reproducing head 54 and writing of information on the magnetic disk 16 is performed by the recording head 58.

FIG. 6 schematically depicts a magnetization state of the write gap WG in a state in which the magnetic permeability adjusting element 65 is functioning.

In the above-described writing of information, as depicted in FIGS. 3 and 6, by passing an alternating current through the recording coil 64 from the power source 80, the main magnetic pole 60 is excited by the recording coil 64, whereby a perpendicular recording magnetic field is applied from the main magnetic pole 60 to the magnetic recording layer 103 of the magnetic disk 16 located directly under the main magnetic pole 60. By doing so, information is recorded in the magnetic recording layer 103 in a desired track width.

Moreover, when the recording magnetic field is applied to the magnetic disk 16, the current Iop is applied from the power source 74 through the wiring 66, the main magnetic pole 60, the magnetic permeability adjusting element 65, and the trailing shield 62. As a result of this application of the current, spin torque acts on the adjusting layer 65b of the magnetic permeability adjusting element 65 from the main magnetic pole 60, and the magnetization of the adjusting layer 65b is directed in a direction opposite to the direction of a magnetic field (a gap magnetic field) Hgap that is generated between the main magnetic pole 60 and the trailing shield 62. As a result of this reversal of magnetization, the adjusting layer 65b shields the magnetic flux (the gap magnetic field Hgap) flowing directly into the trailing shield 62 from the main magnetic pole 60. Consequently, the magnetic field leaking from the main magnetic pole 60 into the write gap WG reduces, whereby the degree of convergence of the magnetic flux heading from the tip portion 60a of the main magnetic pole 60 toward the magnetic recording layer 103 of the magnetic disk 16 is increased. As a result, the resolution of the recording magnetic field is increased and an increase in recording linear density can be achieved.

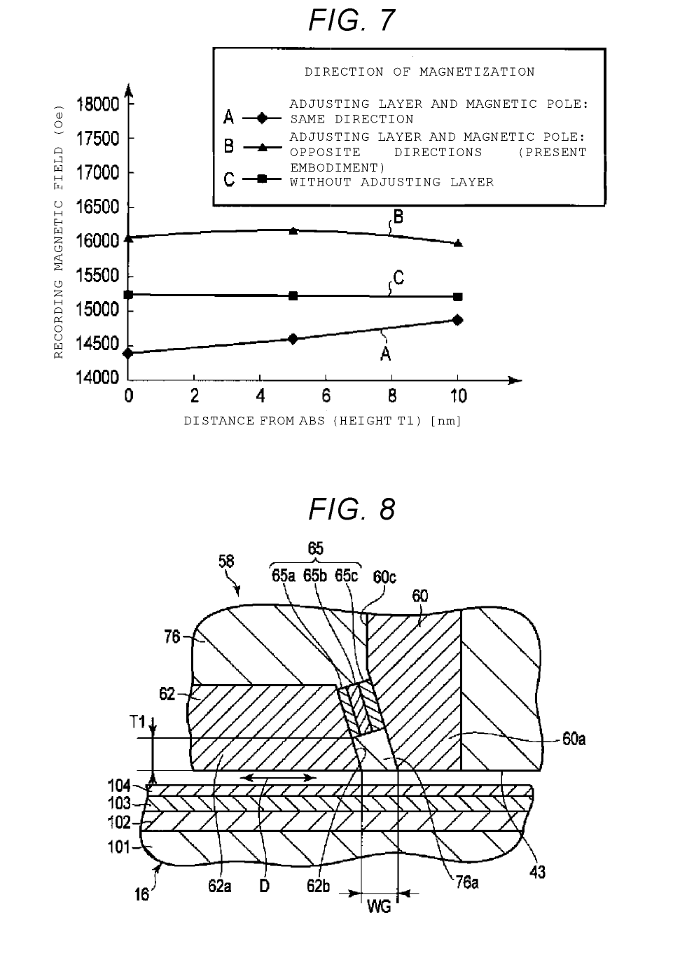

FIG. 7 depicts a relationship between the distance (the height T1) between the magnetic permeability adjusting element 65 and the ABS 43 and the recording magnetic field intensity. In FIG. 7, with reference to a recording magnetic field C observed when the magnetic permeability adjusting element is not formed, changes in a recording magnetic field A in a case where the direction of magnetization of the adjusting layer 65b and the direction of magnetization of the main magnetic pole 60 are the same and a recording magnetic field B in a case where the direction of magnetization of the adjusting layer 65b and the direction of magnetization of the main magnetic pole 60 are opposite to each other (the present embodiment) are depicted. This diagram reveals that, in a case where the direction of magnetization of the adjusting layer 65b and the direction of magnetization of the main magnetic pole 60 are the same, the recording magnetic field A is smaller than the reference recording magnetic field C irrespective of the height T1 of the magnetic permeability adjusting element 65. On the other hand, in a case where the direction of magnetization of the adjusting layer 65b and the direction of magnetization of the main magnetic pole 60 are opposite to each other as in the present embodiment, when the position in which the magnetic permeability adjusting element 65 is provided is moved in the height direction, that is, when the distance (the height T1) from the ABS 43 is increased, the recording magnetic field B becomes greater. In contrast, when the distance (the height T1) exceeds the distance between the trailing shield 62 and the main magnetic pole 60, since the influence on the tip portion 60a of the main magnetic pole 60 which greatly causes the recording magnetic field to decrease, the recording magnetic field B decreases. Based on these facts, preferably, the height T1 in a position in which the magnetic permeability adjusting element 65 is provided is nearly equal to the width of the write gap WG. However, FIG. 7 illustrates that, in any height position, the recording magnetic field B is increased and improved compared to the reference recording magnetic field C.

According to the first embodiment configured as described above, in the recording head 58, the magnetic permeability adjusting element 65 provided in the write gap WG acts so that the magnetic permeability of the gap becomes effectively negative by preventing a direct flow of the magnetic flux into the trailing shield 62 from the main magnetic pole 60. Specifically, the magnetic permeability adjusting element 65 is provided between the main magnetic pole 60 and the trailing shield 62 and is configured so that magnetization is directed in a direction opposite to the gap magnetic field by spin torque. As a result, the magnetic flux flowing into the trailing shield 62 from the main magnetic pole 60 is directed to the magnetic disk (the recording medium) 16 with the write gap WG kept in a narrow state. Therefore, according to the first embodiment, recording density can be increased.

Next, a magnetic recording head of an HDD according to a modified example will be described. In the modified example, the same portions as the portions of the first embodiment will be identified with the same reference characters and the detailed explanations thereof will be omitted, and a portion different from the portion of the first embodiment will be mainly described in detail.

### First Modified Example

FIG. 8 is a cross-sectional view of an enlarged ABS-side end portion of a recording head of an HDD according to a first modified example taken along a track center. The order in which the intermediate layer 65a, the adjusting layer 65b, and the conduction cap layer 65c of the magnetic permeability adjusting element 65 are stacked may be opposite to the order in the first embodiment. As depicted in FIG. 8, according to the first modified example, the intermediate layer 65a, the adjusting layer 65b, and the conduction cap layer 65c of the magnetic permeability adjusting element 65 are stacked in order from the side where the trailing shield 62 is located to the side where the main magnetic pole 60 is located. The intermediate layer 65a is formed directly on the leading-side end face 62b of the trailing shield 62. The conduction cap layer 65c is formed directly on the shield-side end face 60c of the main magnetic pole 60. The formation materials, the film thicknesses, and so forth of the intermediate layer 65a, the adjusting layer 65b, and the conduction cap layer 65c are similar to the formation materials, the film thicknesses, and so forth described in the first embodiment.

Also in the first modified example configured as described above, effects similar to the effects of the first embodiment can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For instance, the materials, shapes, sizes, and so forth of the elements forming the head portion may be changed if necessary. Moreover, in the magnetic disk device, the number of magnetic disks and magnetic heads may be increased when necessary and the size of the magnetic disk may also be selected from among various sizes.

1.-4. (canceled)

5. A magnetic recording head comprising:
a main magnetic pole extending to an air bearing surface of the magnetic recording head and having an end portion that is exposed at the air bearing surface;
a magnetic shield having an end portion that is exposed at the air bearing surface and faces the end portion of the main magnetic pole with a gap therebetween;
a stacked-layer element disposed in the gap, and including a first conductive layer in contact with the end portion of the main magnetic pole, a second conductive layer in contact with the end portion of the magnetic shield, and a magnetic permeability adjusting layer formed of a magnetic material containing at least one of iron, cobalt, and nickel and disposed between the first conductive layer and the second conductive layer; and
first and second terminals between which a current flows through the main magnetic pole, the stacked-layer element, and the magnetic shield when the current is supplied to one of the terminals,
wherein a distance between the stacked-layer element and the air bearing surface is greater than 2 nm.

6. The magnetic recording head according to claim 5, wherein
the magnetic recording head further includes an insulating layer that covers a side of the stacked-layer element that faces the air bearing surface, in the gap, and forms a part of the air baring surface.

7. The magnetic recording head according to claim 5, wherein
a distance between the air baring surface and the stacked-layer element is greater than a width of the gap.

8. The magnetic recording head according to claim 5, wherein
the first conductive layer is formed of metal or metal alloy, including at least one of Cu, Au, Ag, Al, Ir, and NiAl alloy, and
the second conductive layer is formed of metal or metal alloy, including at least one of Ta, Ru, Pt, W, and Mo.

9. The magnetic recording head according to claim 5, wherein
the first conductive layer is formed of metal or metal alloy, including at least one of Ta, Ru, Pt, W, and Mo, and
the second conductive layer is formed of metal or metal alloy, including at least one of Cu, Au, Ag, Al, Ir, and NiAl alloy.

10. The magnetic recording head according to claim 5, wherein
a product of the thickness and a saturation magnetic flux density of the magnetic permeability adjusting layer is equal to or less than 20 nmT.

11.-14. (canceled)

15. A magnetic disk device comprising:
a rotatable disk including a magnetic recording layer; and
a magnetic recording head including
a main magnetic pole extending to an air bearing surface of the magnetic recording head and having an end portion that is exposed at the air bearing surface,
a magnetic shield having an end portion that is exposed at the air bearing surface and faces the end portion of the main magnetic pole with a gap therebetween, and
a stacked-layer element disposed in the gap, and including a first conductive layer in contact with the end portion of the main magnetic pole, a second conductive layer in contact with the end portion of the magnetic shield, and an magnetic permeability adjusting layer formed of a magnetic material containing at least one of iron, cobalt, and nickel and disposed between the first conductive layer and the second conductive layer, wherein
when data are written in the magnetic recording layer, a current flows through the main magnetic pole, the stacked-layer element, and the magnetic shield, and
a distance between the stacked-layer element and the air bearing surface is greater than 2 nm.

16. The magnetic disk device according to claim 15, wherein
the magnetic recording head further includes an insulating layer that covers a side of the stacked-layer element that faces the air bearing surface, in the gap, and forms a part of the air baring surface.

17. The magnetic disk device according to claim 15, wherein
a distance between the air baring surface and the stacked-layer element is equal to or greater than a width of the gap.

18. The magnetic disk device according to claim 15, wherein
the first conductive layer is formed of metal or metal alloy, including at least one of Cu, Au, Ag, Al, Ir, and NiAl alloy, and
the second conductive layer is formed of metal or metal alloy, including at least one of Ta, Ru, Pt, W, and Mo.

19. The magnetic disk device according to claim 15, wherein
the first conductive layer is formed of metal or metal alloy, including at least one of Ta, Ru, Pt, W, and Mo, and
the second conductive layer is formed of metal or metal alloy, including at least one of Cu, Au, Ag, Al, Ir, and NiAl alloy.

20. The magnetic disk device according to claim 15, wherein
a thickness of the magnetic permeability adjusting layer is 1 to 5 nm, and
a product of the thickness and a saturation magnetic flux density of the magnetic permeability adjusting layer is equal to or less than 20 nmT.
